(19) United States
(12) Patent Application Publication
(10) Pub. No.: US 2009/0094239 A1
(43) Pub. Date: Apr. 9, 2009

(54) Systems and Methods for Interaction Between Employers and Professional Recruiters

(76) Inventors: Allan Sabol, Carlsbad, CA (US); Salvador Cepeda, Cosa Grande, AZ (US)

Correspondence Address: FROMMER LAWRENCE & HAUG, 745 FIFTH AVENUE- 10TH FL., NEW YORK, NY, 10151, US

(21) Appl. No.: 11/868,961

(22) Filed: Oct. 8, 2007

(51) Int. Cl. G06F 17/30

(52) U.S. Cl. 707/6; 707/E17.014

(57) ABSTRACT

An automated system with multiple databases and communication methods designed to promote the sharing and transfer of useful information and data between two parties. Specifically, the system is designed for use by employers to communicate more effectively with professional recruiters in order to dramatically increase the effectiveness of matching job candidates with job requisitions. The system creates an online virtual marketplace for employers and professional recruiters to interact and conduct all phases of the recruiting process from start to finish, and thus replaces the need for other forms for recruitment. The two primary users of this system are employers and Recruiters, but there is also some interaction with the system from other entities such as job candidates. For professional recruiters the system allows for the personal tracking, search, storage, matching, and submission of job candidate information and job candidate resumes, and the ability to search, view, track, match, and submit resumes against open job requisitions nationwide. For employers, the system provides a method to post detailed job descriptions, select recruiters to work with, determine recruiting fees, receive and process resumes, coordinate and track the interview process, schedule interviews and employment testing, and receive automated invoices for successful placements.

### BACKGROUND

Potential employers struggle to find qualified recruits, in part because they lack good tools. The “help wanted” ad, placed, e.g. in a newspaper, is well established, but it requires employers to pay in advance for a service that may yield no results. Moreover, such an ad commonly elicits a flood of resumes, often mostly from unqualified applicants. This method can therefore entail spending extra time and money screening candidates in hopes of finding a qualified applicant.

The online job board is scarcely an improvement. Although often cheaper than help-wanted advertising and possibly reaching larger pools of potential job candidates, online job boards have actually worsened the existing problems. Broader distribution of the job announcement often leads to even more applications from unqualified applicants, some of whom are not even eligible to work in the employer's jurisdiction. Screening applicants thereby becomes an even greater burden.

Although multiple variants of the online job board have been tried—including, for example, integration with social networks, support for resume search engines, and allowing applicants to post video resumes—the basic idea has remained the same. Technology is still relied on to link employers to a massive pool of unscreened candidates. But algorithms have yet to be devised to determine accurately the quality of an applicant, nor the applicant's communication skills, professionalism, or attitude.

An established alternative to the printed or electronic help-wanted ad is the full-service recruiting firm. A recruiter is expected to screen applicants before submitting a resume for consideration, ensuring that each applicant suits the employer's needs. A recruiter typically offers further support during interview, which may save employers' time. But using a recruiting firm is costly: professional recruiters may commonly charge 20-33% of the candidate's first year base salary, although this fee is typically not payable until the employer hires a candidate referred by the recruiter.

Online job boards according to the prior art commonly include programmable digital computers, although computers can serve other purposes related to recruiting and hiring. FIG. 1 is a block diagram of an exemplary computer from the prior art. Computer system 100 includes at least one processor 105, such as an Intel Pentium® microprocessor or a Motorola Power PC® microprocessor, coupled to a communications channel 107. The computer system 100 further includes an input device 109 such as, e.g. a keyboard or mouse, an output device 111 such as, e.g. a cathode ray tube or LCD display, a communications interface 113, a data storage device 115 such as, e.g. a magnetic disk or an optical disk, and memory 117 such as, e.g. Random-Access Memory (RAM), each coupled to the communications channel 107. The communications interface 113 may be coupled to a network such as the Internet.

One skilled in the art will recognize that, although the data storage device 115 and memory 117 are depicted as different units, the data storage device 115 and memory 117 can be parts of the same unit or units, and that the functions of one can be shared in whole or in part by the other, e.g. as RAM disks, virtual memory, etc. It will also be appreciated that any particular computer may have multiple components of a given type, e.g., processors 105, input devices 109, communications interfaces 113, etc.

The data storage device 115 and/or memory 117 may store an operating system 120 such as Microsoft Windows XP®, Linux®, Mac OS®, or Unix®. Other programs 122 may be stored instead of or in addition to the operating system. It will be appreciated that a computer system may also be implemented on platforms and operating systems other than those mentioned. Any operating system 120 or other program 122, or any part of either, may be written using one or more programming languages such as, e.g. Java®, C, C++, Objective-C, C#, Visual Basic®, VB.NET®, Perl, Ruby, Python, or other programming languages, possibly using object oriented design and/or coding techniques.

One skilled in the art will recognize that the computer system 100 may also include additional components and/or systems, such as network connections, additional memory, additional processors, network interfaces, input/output busses, for example. One skilled in the art will also recognize that the programs and data may be received by and stored in the system in alternative ways. For example, a computer-readable storage medium (CRSM) reader 124, such as, e.g. a magnetic disk drive, magneto-optical drive, optical disk drive, or flash drive, may be coupled to the communications bus 107 for reading from a computer-readable storage medium (CRSM) 126 such as, e.g. a magnetic disk, a magneto-optical disk, an optical disk, or flash RAM. Accordingly, the computer system 100 may receive programs and/or data via the CRSM reader 124. Further, it will be appreciated that the term “memory” herein is intended to cover all data storage media, whether permanent or temporary, including among other things the data storage device 115, the memory 117, and CSRM 126.

Two or more computer systems 100 may be connected, e.g. in one or more networks, via, e.g. their respective communications interfaces 115 and/or network interfaces (not depicted). FIG. 2 depicts interconnected networks 150 according to the prior art, such as may be useful in connection with embodiments of the invention.

An network 152 may, for example, connect one or more workstations 154 with each other and with other computer systems, such as file servers 156 or mail servers 158. The connection may be achieved tangibly, e.g. via Ethernet® or optical cables, or wirelessly, e.g. through use of modulated microwave signals according to the IEEE 802.11 family of standards. A computer system that participates in the network may send data to another computer system in the network via the network connection.

One use of a network 152 is to enable a computer system to provide services to other computer systems, consume services provided by other computer systems, or both. For example, a file server 156 may provide common storage of files for the workstations 154 on a network 152. A workstation 159 sends data, including a request for a file, to the file server 156 via the network 152, and the file server 156 may respond by sending the data from the file back to the requesting workstation 159.

As will be recognized by those skilled in the relevant art, the terms “workstation,” “client,” and “server” are used herein to describe a computer's function in a particular context. A workstation may, for example, be a computer that one or more users work with directly, e.g. through a keyboard and monitor directly coupled to the computer system. A computer system that requests a service through a network is often referred to as a client, and a computer system that provides a service is often referred to as a server. But any particular workstation may be indistinguishable in its hardware, configuration, operating system, and/or other software from a client, a server, or both.

Further, a computer system may simultaneously act as a workstation, a server, and/or a client. For example, as depicted in FIG. 2, a workstation 160 is connected to a printer 161. That workstation 160 may allow users of other workstations on the network 152 to use the printer 161, thereby acting as a print server. At the same time, however, a user may be working at the workstation 160 on a document that is stored on the file server 156.

A network 150 may be connected to one or more other networks 150, e.g. via a router 165. A router 165 may also act as a firewall, monitoring and/or restricting the flow of data to and/or from a network 152 as configured to protect the network. A firewall may alternatively be a separate device (not pictured) from the router 165.

A network of networks 150 may be referred to as an internet. “The Internet” 170 refers to the worldwide network of interconnected, packet-switched data networks that uses the Internet Protocol (IP) to route and transfer data. A client and server on different networks 150 may communicate via the Internet 170. For example, a workstation 159 may request a World Wide Web document from a Web Server 175. The Web Server 175 may process the request and pass it to, e.g. an Application Server 177. The Application Server 177 may then conduct further processing, which may include, for example, sending data to and/or receiving data from one or more other data sources. Such a data source may include, e.g. other servers on the same or different network 150 and/or a Database Management System (“DBMS”) 179.

### BRIEF SUMMARY OF THE INVENTION

The present invention relates to systems and methods for interaction between employers and professional recruiters. More specifically, it relates to methods by which an employer may publish a job listing for review by professional recruiters, and further by which recruiters may identify candidates and submit them to employers for consideration. Flexible search facilities are provided. Facilities are also provided for the setting of the recruiter's fee for a successful placement and for employers and recruiters to rate one another.

Thus, according to an embodiment of the invention, a method of selecting a candidate for a job offered by an employer, comprises matching at least one candidate profile, comprising information describing the candidate, from a candidate database that comprises a plurality of candidate profiles with at least one job listing, comprising information describing a job offered by the employer and specifying a first offer of compensation to a recruiter who refers a candidate whom the employer hires for the job, from a job database that comprises a plurality of job listings; and sending information comprised by the candidate profile to the employer.

According to an embodiment of the invention, the method comprises storing at least one matched job listing in a job list. According to another embodiment, the method comprises receiving a notice that the employer associated with one of the job listings on the job list has made a second offer of compensation to the recruiter who refers a candidate whom the employer hires for the job.

In an embodiment of the invention, matching according to the method comprises comparing the information in at least of the candidate profiles within the candidate database with information in at least one of the job profiles within the job database, based upon a plurality of weighted criteria. The method may comprise comparing information in exactly one candidate profile with information in a plurality of the job profiles. Alternatively, the method may comprise comparing information in exactly one job profile with information in a plurality of the candidate profiles.

According to an embodiment of the invention, the method comprises providing information comprising a rating of the employer. In an embodiment of the invention, at least one job listing comprises information based on the rating of the employer.

According to an embodiment of the invention, the method comprises receiving notification that the employer wishes to interview the candidate, wherein any indicia within the job listing of the identity of the employer omits the true identity of the employer, and wherein the true identity of the employer is disclosed only contemporaneously with or after receipt of notification that the employer wishes to interview the candidate.

According to an embodiment of the invention, a method is provided of identifying a candidate, represented by a recruiter, for a job offered by an employer. The method comprises creating a job listing, comprising information describing the offered job and specifying a first offer of compensation to a recruiter who refers a candidate whom the employer hires for the job, within a job database that comprises a plurality of job listings; and receiving from a recruiter at least one candidate profile, comprising information describing the candidate, from a candidate database that comprises a plurality of candidate profiles.

According to an embodiment of the invention, the method comprises receiving a suggested value for the first offer of compensation, the value having been computed according to an algorithm based at least in part upon the information in the job listing.

In an embodiment of the invention, the method comprises recording at least one rating of at least one recruiter. The method may further comprise designating at least one of the rated recruiters as a preferred recruiter and sending a notification of the job listing to at least one designated preferred recruiter. According to an embodiment of the invention, designating at least one of the rated recruiters as a preferred recruiter is based at least in part on at least one of the ratings recorded for the recruiter.

In an embodiment of the invention, the method comprises designating at least one of the rated recruiters as a blocked recruiter and sending a notification of the job listing to a plurality of recruiters that excludes the at least one blocked recruiter. In such an embodiment, designating at least one of the rated recruiters as a blocked recruiter may be based at least in part on at least one of the ratings recorded for the recruiter. In another embodiment of the invention, the method comprises designating at least one of the rated recruiters as a blocked recruiter and publishing the job listing to a job database accessible by at least one recruiter, wherein no blocked recruiter may retrieve the job listing.

In an embodiment of the invention, the method comprises editing the job listing by replacing the first offer of compensation with a second offer of compensation to a recruiter who refers a candidate whom the employer hires for the job. The method may comprise receiving a suggested value for the second offer of compensation, the value having been computed according to an algorithm based at least in part upon the information in the job listing.

An embodiment of the invention comprises a computerized system for matching candidates with job openings, comprising an input/output module, an employer interface coupled to the input/output module, a recruiter interface coupled to the input/output module, a job database, a candidate database, a controller module coupled to the input/output module, the job database, and the candidate database, and a search engine coupled to the controller module, the job database, and the candidate database. The controller module is operative to cause the system to carry out a method that comprises creating a job listing, comprising information describing an offered job and specifying a first offer of compensation to a recruiter who refers a candidate whom the employer hires for the job, in the job database in response to input received through the employer interface; creating a candidate profile in the candidate database in response to input received through the recruiter interface; searching within the job database, the candidate database, or both; identifying at least one of the job listings that matches at least one of the candidate profiles, based on the results of searching; providing information related to at least one of the matching job listings or candidate profiles through the recruiter interface; and in response to input received through the recruiter interface, providing information related to at least one of the matching job listings or candidate profiles through the employer interface.

### BRIEF DESCRIPTION OF THE DRAWINGS

The invention is illustrated in the figures of the accompanying drawings, which are meant to be exemplary and not limiting, and in which like references are intended to refer to like or corresponding things.

FIG. 1 is a block diagram depicting a programmable digital computer according to the prior art.

FIG. 2 is a block diagram depicting internetworked computer systems according to the prior art.

FIG. 3 depicts a recruiting system according to an embodiment of the invention.

FIG. 4 depicts recruiting and hiring a candidate according to an embodiment of the invention.

FIG. 5 depicts posting a job opening according to an embodiment of the invention.

FIG. 6 depicts editing of a posted job opening according to an embodiment of the invention.

FIG. 7 depicts submission by a recruiter of a candidate to an employer according to an embodiment of the invention.

FIG. 8 depicts evaluation of a candidate according to an embodiment of the invention.

### DETAILED DESCRIPTION OF THE PREFERRED EMBODIMENTS

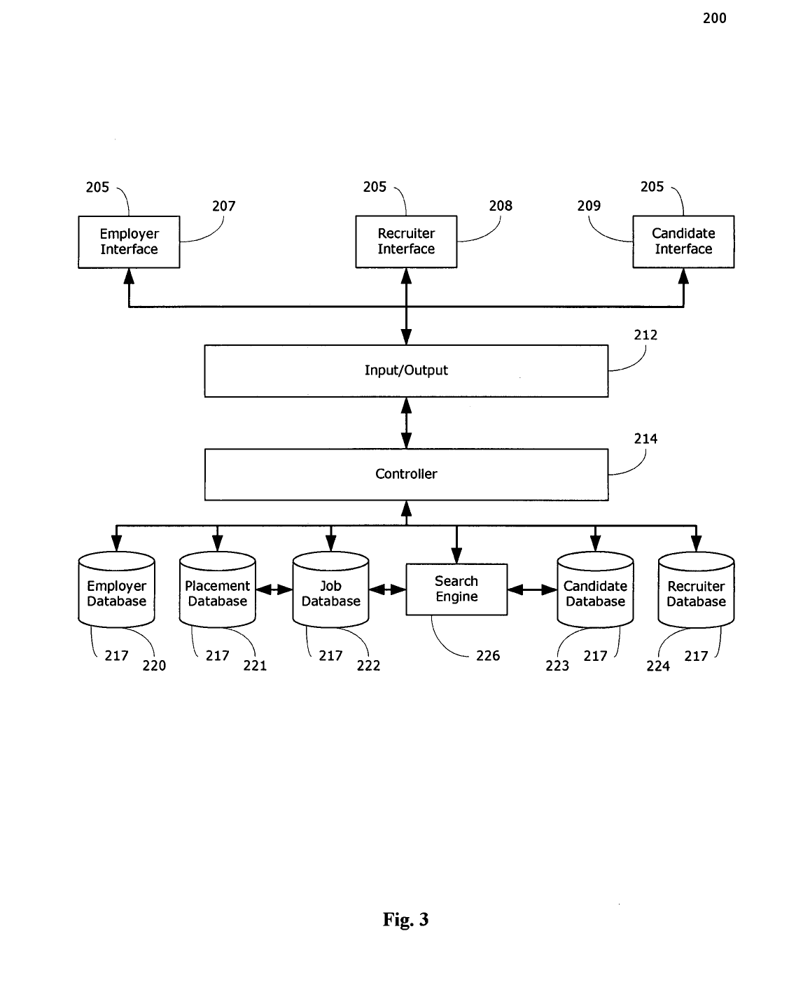

FIG. 3 depicts the logical components of a recruiting system 200 according to an embodiment of the invention. As depicted, the system comprises three interfaces 205 for communication with the different classes of users: an employer interface 207, a recruiter interface 208, and a candidate interface 209. In an embodiment of the invention, each interface 205 comprises one or more of software, data, and markup capable of causing information to be sent to and received from a user. For example, a Web interface (not pictured) may comprise, e.g. text, images, data fields, forms, drop down menus, data entry tools, and other elements to present information, accept input, or both.

Each interface 205 connects to an input/output module 212, which may, e.g. identify and/or validate input and/or determine how input is to be processed. A controller module 214 carries out processing as requested and controls functions of the rest of the system 200. The controller module may 214 may also cause the input/output module 212 to provide, e.g. one or more results of processing to a user via the appropriate interface 205.

The controller module 214 also interacts with one or more databases 217. In the depicted embodiment of the invention, these include an employer database 220, a placement database 221, a job database 222, a candidate database 223, and a recruiter database 224. The controller also controls a search engine 226, which, in the depicted embodiment of the invention, is configured to search within, and retrieve results from, the job database 222 and the candidate database 223. It will be appreciated by those skilled in the art that in an embodiment of the invention, a search engine may be configured to function in connection with any or all of the depicted databases 217 or to interact with a database or databases in addition to or instead of some or all of the depicted databases 217.

It will be appreciated that the modules depicted in FIG. 3 represent logical elements in an abstract description of a data processing system. In an embodiment of the invention, software implementing one or more logical elements may comprise one or more software modules and/or sub-modules. Moreover, without limiting the foregoing, functionality depicted in FIG. 3 as comprising more than one logical element may in an embodiment be implemented in a single software module or sub-module.

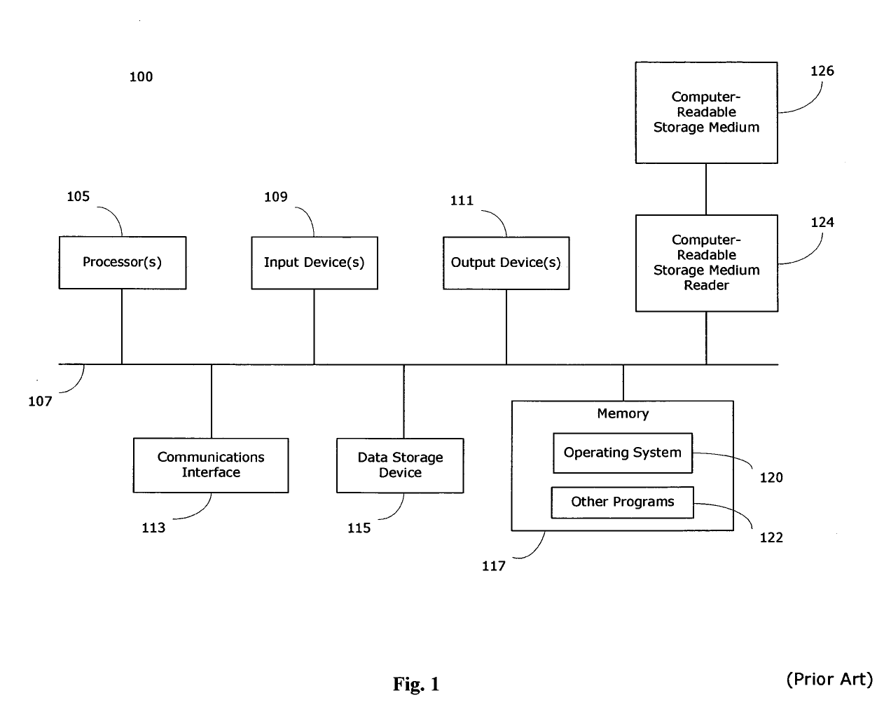

In an embodiment of the invention, the modules depicted in FIG. 3 are on one or more computer systems 100 (FIG. 1). One skilled in the art will recognize that all modules may be on a single computer system 100 or the modules may be distributed between a plurality of computer systems 100; that one or more modules may be substantially duplicated on a plurality of computer systems 100; that one or more modules may be distributed across a plurality of computer systems 100; and that various permutations of these configurations are possible in different embodiments of the invention.

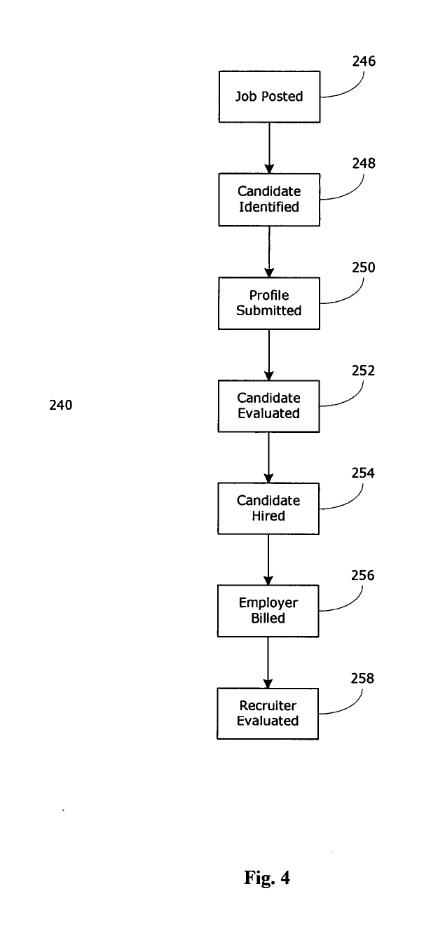

FIG. 4 is an overview 240 of recruiting and hiring a candidate according to an embodiment of the invention. In block 246, an employer posts a job opening, e.g. by entering data through the Employer Interface 207 (FIG. 3), which is then stored, e.g. in the Job Database 222 (FIG. 3). The Employer Interface 207 may comprise, e.g. a job creation form comprising one or more data fields used during the matching and search processes. In an embodiment of the invention, the employer can specify the fee that the employer is willing to pay to the recruiter responsible for introducing a candidate who is ultimately hired.

Block 248 in FIG. 4 represents creation of a profile for a candidate in accordance with an embodiment of the invention. In an embodiment of the invention, a recruiter creates a candidate record in the Candidate Database 223 (FIG. 3). Depending on the embodiment of the invention, the Candidate Database 223 may be a database exclusive to the particular recruiter or a portion of a larger database shared by two or more recruiters. In an embodiment of the invention, the Candidate Database 223 used by a recruiter may be restricted, e.g. so that only that recruiter and/or one or more specified individuals can have access to the database.

Depending on the embodiment of the invention, candidate data in block 248 (FIG. 4) may be entered, e.g. by a recruiter through the Recruiter Interface 208 (FIG. 3), by a candidate through the Candidate Interface 209 (FIG. 3), or both. An embodiment of the invention may comprise a way for a recruiter to specify custom data fields for inclusion in candidate profiles. Such recruiter-specified information may, depending on the embodiment of the invention and the configuration of the system, include data other than and/or in addition to a standard set of data specified in connection with the embodiment of the invention.

In block 250 (FIG. 4), the recruiter matches a posted job opening from the Job Database 222 (FIG. 3) with a candidate whose profile is in the Candidate Database 223 (FIG. 3). As further discussed below, the matching in block 250 may comprise, e.g. one or more of searching within the Job Database 222 (FIG. 3) for postings that seem suitable in view of a candidate's profile, searching within the Candidate Database 223 (FIG. 3) for candidates who seem suitable in view of a job posting, and searching based on certain criteria in some combination of the Job Database 222 and the Candidate Database 223. Matching according to an embodiment of the invention may comprise interaction between the recruiter and a candidate, such as an interview and/or review of job postings. Once the recruiter has found one or more matches, the recruiter submits one or more candidates' profiles to the employer or employers corresponding to one or more job listings.

Electronic messaging, including, e.g. electronic mail and instant messaging may be provided in connection with an embodiment of the invention. Such electronic messaging may serve to convey, e.g. some or all notices or communications in connection with an embodiment of the invention.

The employer evaluates the candidate in block 252. In an embodiment of the invention, the employer reviews the candidate's profile and sends a response to the recruiter, e.g. through an electronic messaging system according to an embodiment of the invention. According to an embodiment of the invention, possible responses may include, for example, a rejection of the candidate, an expression of a desire to interview the candidate, or a request for further information regarding the candidate.

A request for information in block 252 may lead to a response from the recruiter and/or the candidate. Following the response, the employer may once again, e.g. reject the candidate, express a desire to interview the candidate, or ask for further information regarding the candidate.

According to an embodiment of the invention, the true identity of the employer may remain masked until an interview is arranged between the employer and the candidate.

Following a favorable evaluation in block 252, the employer may in block 254 offer a job to the candidate. According to an embodiment of the invention, the employer may submit the offer electronically, and the candidate may, similarly, send an electronic acceptance. After the candidate accepts the offer, either the employer or the recruiter may create a hiring record, which may include among other things the dated on which the hired candidate will start the new job.

In an embodiment of the invention, creation of the hiring record initiates billing, depicted in block 256. Billing processes and practices may vary, but, in one embodiment of the invention, they may reflect certain customary terms. An embodiment of the invention may comprise integration with one or more accounting systems of the recruiter and/or the employer.

It may be possible in an embodiment of the invention for a user to record one or more ratings of another party involved in recruiting a candidate. Block 258 represents an employer's review of the service provided by a recruiter following use of that recruiter to find a new employee. According to an embodiment of the invention, an employer may judge a recruiter on criteria comprising, e.g. one or more of the recruiter's responsiveness, professionalism, quality of provided candidates, etc. An employer may use an algorithm, e.g. to compute a weighted average of the various ratings and this overall rating may be provided, e.g. graphically to members of the employer's personnel department.

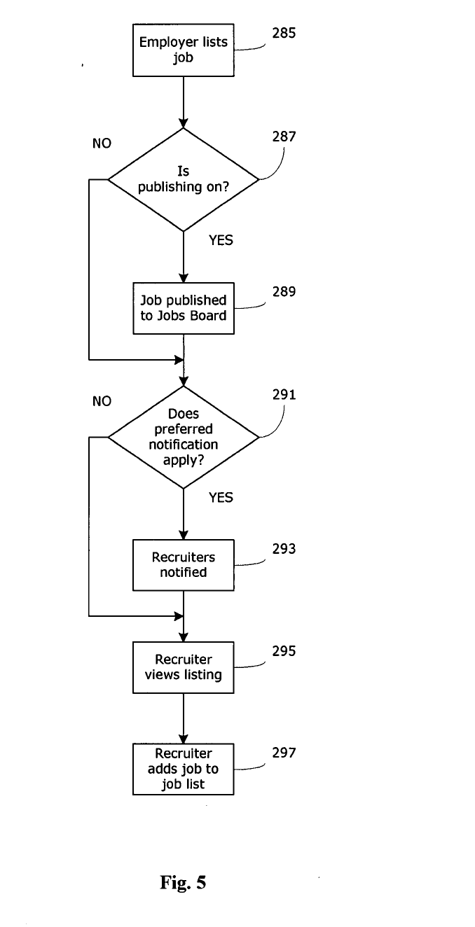

Addition of a new job listing is depicted in more detail in FIG. 5. In block 285, an employer creates a new job listing. According to an embodiment of the invention, the new listing may be added by default only to the employer's private job database. If in block 287 it is determined that the employer has chosen to publish the job listing, e.g. by setting a property of the individual job listing or by having changed one or more properties applicable by default to all new job listings or to one or more classes of new job listings, the job listing is published in block 289.

A “preferred” status may exist according to an embodiment of the invention. For example, a recruiter may be considered a preferred recruiter in connection with a particular employer, and, in an embodiment of the invention, a recruiter's preferred status may be based, in whole or in part, in one or more ratings created in block 258 of FIG. 4. Conversely, a recruiter may according to an embodiment of the invention designate one or more preferred employers.

In an embodiment of the invention, preferred status—of a recruiter with regard to an employer or of an employer with regard to a recruiter—may cause a notification of a new job listing to be sent to one or more recruiters. Block 291 represents determining whether such a circumstance applies. According to an embodiment of the invention, when an employer creates a new job listing, all of that employer's preferred recruiters receive notification of the listing, whether or not the listing was published in block 289. In an alternative embodiment, such notice may depending upon one or more criteria be limited to one or more specific recruiters and/or one or more specified groups of recruiters.

By designating an employer as a preferred employer, a recruiter may according to an embodiment of the invention also receive notice of any listings from that employer that have been published to the Jobs Board in block 289. In an embodiment of the invention, listings not published to the Jobs Board are private and not available except to those recruiters notified by the employer, including, e.g. preferred recruiters, as discussed above.

According to an embodiment of the invention, a “blocked” status is possible, which is, e.g. the opposite of the preferred status discussed above. An employers may block one or more recruiters, and, once blocked, a recruiter will be, e.g. unable to submit candidate profiles or otherwise to contact the recruiter through the system. According to an embodiment of the invention, a recruiter may similarly block one or more employers. Support for blocking status may protect a user from, e.g. spam or other improper solicitation or abuse of the system.

If in block 291 it is determined that preferred notification does apply, such notice is sent, e.g. by email, in block 293.

After receiving a notice of a new job listing, an employer may view the listing in block 295. In an embodiment of the invention, the notice is provided by email, and the email includes, e.g. a hyperlink to a Web page that displays the listing. Other means of notice may be used instead of or in addition to email, such as, e.g. one or more indicia provided by the Recruiter Interface 208 (FIG. 3).

According to an embodiment of the invention, a recruiter may establish one or more job lists. After viewing a listing in block 295, the recruiter may save the listing to a job list in block 297.

In an embodiment of the invention, a recruiter may find job listings other than by receiving a notice. For example, a recruiter may search within one or more published job boards (not pictured). The search may return one or more listings, and the recruiter may retrieve and review some or all of the returned listings, as in block 295. A recruiter may add any such listing to the recruiter's job list in block 297.

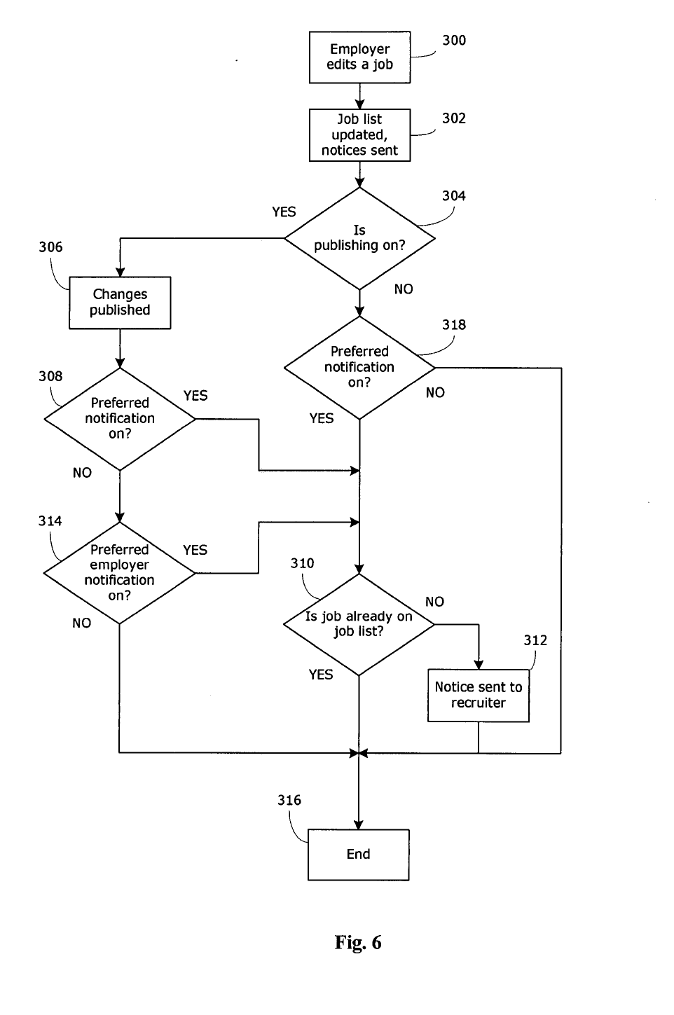

FIG. 6 depicts editing a job listing according to an embodiment of the invention. Such editing may take place, e.g. to correct an error in the initial listing. Another exemplary reason for editing a listing may be to alter the employer's offered compensation to any recruiter who refers a candidate to the employer whom the employer ultimately hires. Other types of edits and reasons for them are possible.

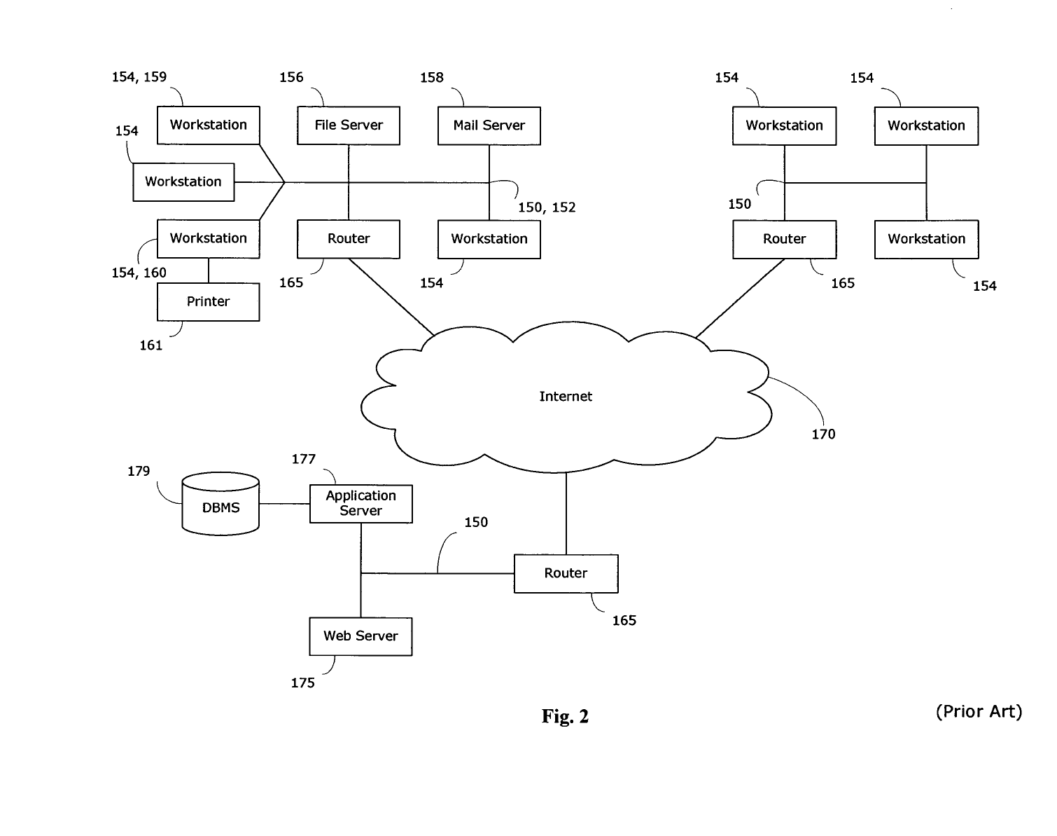

In block 300, the employer edits the listing, e.g. through the Employer Interface 207 (FIG. 2). When the editing is complete, the employer's job list is updated in block 302 to reflect any changes. In an embodiment of the invention, any recruiter who has added the listing to a job list, e.g. in block 297 (FIG. 5), is sent a notice of update in block 302 as well.

It is determined in block 304 whether the changes to the listing are to be published. According to an embodiment of the invention, this determination reflects, e.g. the employer's choice to publish the job listing as discussed in connection with FIG. 5, e.g. by setting a property of the individual job listing or by having changed one or more properties applicable by default to all new job listings or to one or more classes of new job listings. If the listing or an edit thereto is to be published, then in block 306 the changes are reflected in a database or databases accessible to recruiters generally.

It is determined in block 308 whether the employer has identified any preferred recruiters who are to receive notice of the edit. If so, it is determined in block 310 whether the listing is on any preferred recruiters' job lists. If so, then, according to an embodiment of the invention, those recruiters will already have received notice in block 302, and no duplicate notice is sent. If the edited listing is not on a preferred recruiter's jobs list, then notice is sent to each such recruiter in block 312.

If the employer has not identified any preferred recruiters, then in block 314 it is determined whether any recruiters have requested notification of edits to listings from this preferred employer. Again, in an embodiment of the invention, if any recruiters have requested notice, it is determined in block 310 whether any such recruiters already have the edited listing on their job lists, again to prevent duplicate notices. Each recruiter who does not have the edited listing on a job list is sent a notice in block 312.

FIG. 6 may be taken to suggest that recruiters' lists of preferred employers will be checked in block 314 only if the employer has not selected any preferred recruiters who are identified in block 308. In an embodiment of the invention, the checks in blocks 308 and 314 are made cumulatively for each recruiter. In other words, according to an embodiment of the invention, any recruiter who does not have the listing on a job list will nonetheless receive notice of the changed listing if the recruiter is on the employer's preferred recruiter list, or if that recruiter has added the employer to the recruiter's list of preferred employers.

Even if it is determined in block 304 that the listing is not published, notice may still be sent to preferred recruiters designated by the employer. In block 318, it is determined whether preferred notification is on. If so, then it is determined in block 310 whether any such recruiters already have the edited listing on their job lists, again to prevent duplicate notices. Each preferred recruiter who does not have the edited listing on a job list is sent a notice in block 312.

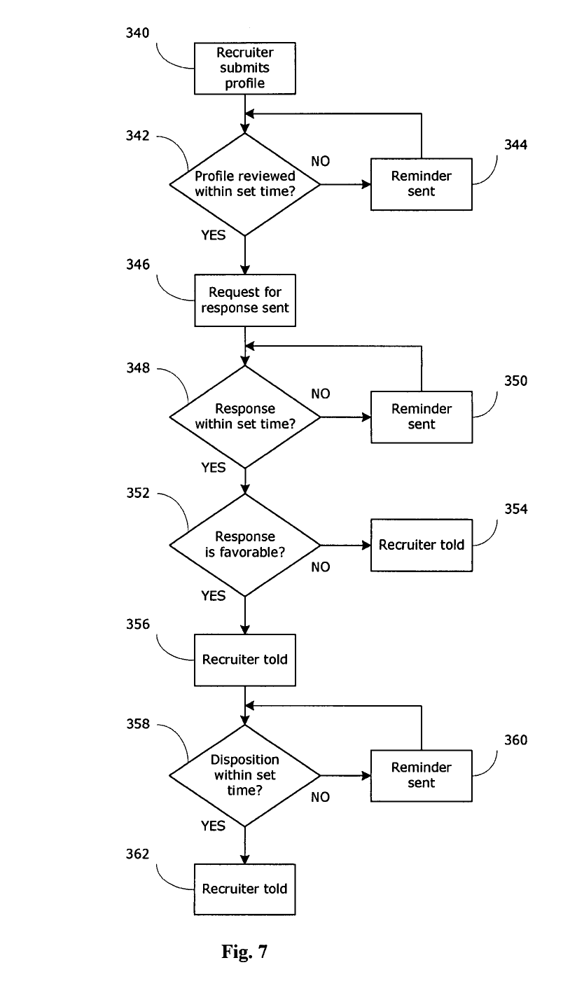

FIG. 7 depicts submission and evaluation of a candidate from the perspective of a recruiter, according to an embodiment of the invention. In block 340, the recruiter submits a candidate's profile to an employer in response to a job listing. The profile may in an embodiment of the invention be equivalent to a resume and may typically include, e.g. a description of the applicant and the applicant's qualifications and experience.

The time taken to respond to one or more actions may be monitored according to an embodiment of the invention. For example, as depicted in FIG. 7, if in block 342 it is determined that the employer has not reviewed a profile within a specified time, a reminder may be sent as in block 344. As depicted, in an embodiment of the invention, multiple reminders may be sent, or, in an embodiment of the invention, only one such reminder may be sent.

Once it has been determined in block 346 that an employer has seen a candidate's profile, a request for the employer to act on the profile may be sent in block 346. As with the initial profile, if it is determined in block 348 that the employer has not acted within a specified time, one or more reminders may be sent as in block 350.

If the employer's response is determined in block 352 to be unfavorable, for example, if the employer chooses not to interview the candidate, the recruiter is notified in block 354, and the process ends with regard to that candidate. If, however, the employer wishes to proceed further, the recruiter is informed in block 356. According to an embodiment of the invention, this notification may be the first time that the recruiter learns the actual identity of the prospective employer.

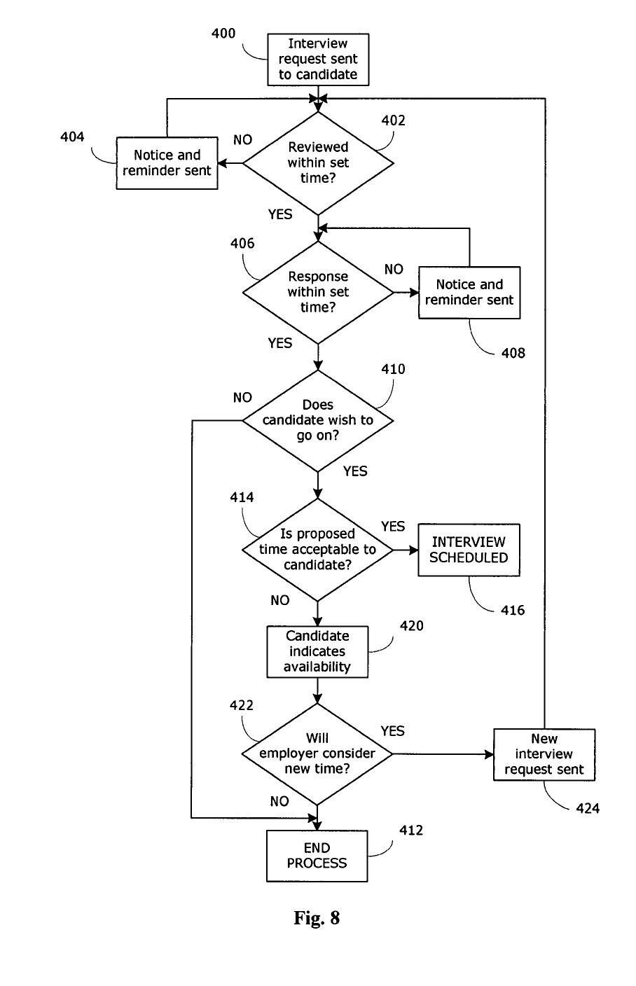

Arranging an interview according to an embodiment of the invention is depicted in greater detail in FIG. 8. In block 400, an interview request is sent, e.g. electronically, to the candidate. This request may, in an embodiment of the invention, be sent at roughly the same time as the notification to the recruiter in block 356 (FIG. 7).

To ensure that the candidate timely responds to the interview request, a check is made in block 402 whether the candidate has reviewed the request within a set time. In an exemplary embodiment of the invention, this time is 48 hours. If the candidate has not reviewed the request within the set time, then, in block 404, a reminder is sent to the candidate, and the recruiter is notified of the delay.

Once the candidate has reviewed the interview request, a check is made in block 406 to ensure that the candidate timely responds. If the candidate has not responded within a set time, which is 24 hours in an exemplary embodiment of the invention, then, in block 408, a reminder is sent to the candidate, and the recruiter is notified of the delay.

If the candidate is determined in block 410 not to be interested in the pursuing the opportunity further, the process ends with regard to that candidate in block 412. If the candidate does wish to proceed, the candidate is asked in block 414 to indicate whether the proposed time and date for an interview is acceptable. In an alternative embodiment of the invention, the candidate may be given two or more proposed times and dates and be asked to select the one that is most convenient. If a proposed time is acceptable, the interview is scheduled in block 416.

If the candidate rejects the proposed interview time or times, then the candidate is asked in block 420 to indicate one or more convenient times, which are then sent to the employer for consideration. If the employer indicates in block 422 that no new times will be considered, the process ends with regard to that candidate at block 412. If the employer is willing to consider a new time, then a revised interview notice is sent in block 424, and the system once again checks for timely review and response in block 402 and subsequent blocks.

An employer's interaction with a candidate may have any of several possible resolutions. For example, the employer may offer the job to the candidate, and the candidate may either accept or reject the offer, possibly after negotiating some of the term of employment. The employer may, alternatively, choose not to offer the job to the candidate and hire someone else. In some cases, the employer may choose simply to leave the position unfilled.

According to an embodiment of the invention, the recruiter is paid only if the employer hires a candidate whom the recruiter referred to the employer, which may induce the recruiter to be interested in which of the preceding resolutions occurs. Returning to FIG. 7, in block 358, it is determined whether the employer has, within a specified time, informed the recruiter of the disposition of the referral. If the employer has not timely given any information, a reminder is sent in block 360, which may, for example, ask the employer to indicate that the candidate has been rejected, to add a placement record indicating that the candidate has been hired, or to close the job listing.

Once the employer has indicated a resolution, the recruiter is notified in block 362. If the resolution includes hiring the applicant, then, according to an embodiment of the invention, the recruiter's billing and/or accounting system may receive notification that a fee is now payable. This notification may be automatic and/or electronic. In an embodiment of the invention, a bill may automatically generated and sent to the employer.

The foregoing descriptions are not be construed to limit the scope of the invention, but rather to illustrate one preferred embodiment thereof. Other embodiments are possible, some of which are also disclosed herein. The invention is delimited only by the attached claims and their legal equivalents.

We claim:

1. A method of selecting a candidate for a job offered by an employer, comprising:
matching at least one candidate profile, comprising information describing the candidate, from a candidate database that comprises a plurality of candidate profiles with at least one job listing, comprising information describing a job offered by the employer and specifying a first offer of compensation to a recruiter who refers a candidate whom the employer hires for the job, from a job database that comprises a plurality of job listings; and
sending information comprised by the candidate profile to the employer.

2. The method of claim 1, comprising storing at least one matched job listing in a job list.

3. The method of claim 2, comprising receiving a notice that the employer associated with one of the job listings on the job list has made a second offer of compensation to the recruiter who refers a candidate whom the employer hires for the job.

4. The method of claim 1, wherein matching comprises comparing the information in at least of the candidate profiles within the candidate database with information in at least one of the job profiles within the job database, based upon a plurality of weighted criteria.

5. The method of claim 4, wherein matching comprises comparing information in exactly one candidate profile with information in a plurality of the job profiles.

6. The method of claim 4, wherein matching comprises comparing information in exactly one job profile with information in a plurality of the candidate profiles.

7. The method of claim 1, comprising providing information comprising a rating of the employer.

8. The method of claim 7, wherein at least one job listing comprises information based on the rating of the employer.

9. The method of claim 1, comprising:
receiving notification that the employer wishes to interview the candidate;
wherein any indicia within the job listing of the identity of the employer omits the true identity of the employer; and
wherein the true identity of the employer is disclosed only contemporaneously with or after receipt of notification that the employer wishes to interview the candidate.

10. A method of identifying a candidate, represented by a recruiter, for a job offered by an employer, comprising:
creating a job listing, comprising information describing the offered job and specifying a first offer of compensation to a recruiter who refers a candidate whom the employer hires for the job, within a job database that comprises a plurality of job listings; and
receiving from a recruiter at least one candidate profile, comprising information describing the candidate, from a candidate database that comprises a plurality of candidate profiles.

11. The method of claim 10, comprising receiving a suggested value for the first offer of compensation, the value having been computed according to an algorithm based at least in part upon the information in the job listing.

12. The method of claim 10, comprising recording at least one rating of at least one recruiter.

13. The method of claim 12, comprising:
designating at least one of the rated recruiters as a preferred recruiter; and
sending a notification of the job listing to at least one designated preferred recruiter.

14. The method of claim 13 wherein designating at least one of the rated recruiters as a preferred recruiter is based at least in part on at least one of the ratings recorded for the recruiter.

15. The method of claim 12, comprising:
designating at least one of the rated recruiters as a blocked recruiter; and
sending a notification of the job listing to a plurality of recruiters that excludes the at least one blocked recruiter.

16. The method of claim 15, wherein designating at least one of the rated recruiters as a blocked recruiter is based at least in part on at least one of the ratings recorded for the recruiter.

17. The method of claim 12, comprising:
designating at least one of the rated recruiters as a blocked recruiter; and
publishing the job listing to a job database accessible by at least one recruiter;
wherein no blocked recruiter may retrieve the job listing.

18. The method of claim 10, comprising editing the job listing by replacing the first offer of compensation with a second offer of compensation to a recruiter who refers a candidate whom the employer hires for the job.

19. The method of claim 18, comprising receiving a suggested value for the second offer of compensation, the value having been computed according to an algorithm based at least in part upon the information in the job listing.

20. A computerized system for matching candidates with job openings, comprising:
an input/output module;
an employer interface, coupled to the input/output module;
a recruiter interface, coupled to the input/output module;
a job database;
a candidate database;
a controller module, coupled to the input/output module, the job database, and the candidate database; and
a search engine, coupled to the controller module, the job database, and the candidate database;
wherein the controller module is operative to cause the system to carry out a method that comprises
creating a job listing, comprising information describing an offered job and specifying a first offer of compensation to a recruiter who refers a candidate whom the employer hires for the job, in the job database in response to input received through the employer interface;
creating a candidate profile in the candidate database in response to input received through the recruiter interface;
searching within the job database, the candidate database, or both;
identifying at least one of the job listings that matches at least one of the candidate profiles, based on the results of searching;
providing information related to at least one of the matching job listings or candidate profiles through the recruiter interface; and
in response to input received through the recruiter interface, providing information related to at least one of the matching job listings or candidate profiles through the employer interface.
